(19) United States
(12) Patent Application Publication
(10) Pub. No.: US 2018/0113663 A1
(43) Pub. Date: Apr. 26, 2018

(54) BROWSER BASED DISPLAY SYSTEM FOR DISPLAYING IMAGE DATA

(71) Applicant: BARCO N.V., Kortrijk (BE)

(72) Inventor: Saurabh JAIN, Saratoga, CA (US)

(73) Assignee: BARCO N.V., Kortrijk (BE)

(21) Appl. No.: 15/565,590

(22) PCT Filed: Apr. 13, 2016
(86) PCT No.: PCT/EP2016/058153

§ 371 Date: Oct. 10, 2017

Related U.S. Application Data
(60) Provisional application No. 62/146,739, filed on Apr. 13, 2015.

(51) Int. Cl. G06F 3/14; G06F 3/02; G06F 3/0354

(52) U.S. Cl. CPC G06F 3/1423; H04L 67/10; G06F 3/03543; G06F 3/0227

(57) ABSTRACT

A system, a workstation, and a method with which an operator can simultaneously access and evaluate data available on different computers or sources, the data being displayed on one or more display devices and interaction with the displays being done through one keyboard and one mouse. Furthermore, the system, the workstation, or the method are flexible enough to allow the addition of an arbitrary number of operator's workstations with little impact on the existing system. Additionally, the system, the workstation, or the method allows modification of the number of displays on a given workstation easily. The system, the workstation, or the method also allows to transfer visual data from one display to another as well as tiling an image across several displays easily.

The present invention relates to display systems, methods of operating such display systems to control the display of media, workstations for such systems, and software for implementing such methods.

### Background

The prior art addresses ergonomics of workstations (an area like e.g. a desk that has the equipment needed for one person to do a particular job) in different ways.

For instance, in U.S. Pat. No. 4,748,574 “Integrated Executive Desk Unit”, part of a desk is set aside for equipment like communication means, input means like e.g. a keyboard and computation means in order to limit the loss of productivity caused by paper clutter in a writing area of the desk.

The solution proposed in U.S. Pat. No. 4,748,574 does not allow the addition of new electronics equipment like e.g. a second phone line, a display or a personal computer.

U.S. Pat. No. 6,774,450 describes a thin client network using Java applets to provide dynamic content in html documents served by a server.

US2013/0206194 describes a system for distributing images from a central server to a local computing device or a site controller both of which can communicate with two display units.

US2012/0317487 describes a system controlled by browsers for viewing content on a viewing device that is presented from a presenter device.

US2014/0280756 describes communications with browsers and a host computer.

Solutions exist where one or more computers are positioned remotely from the workstation. This prevents the workstation and its immediate surroundings to be cluttered by the computers. To avoid having to use several human-machine interfaces like e.g. keyboard, display and pointing device, at the same workstation, keyboard video and mouse switches or KVM switches were used in the prior art.

A known workstation in a control room may include numerous computer systems, all of which must be accessible by an operator. A number of known approaches have been utilized to allow an operator to conveniently access computer systems in the network. FIG. 1, corresponding to FIG. 1 of US2003/0037130 by Rollins, is a functional block diagram illustrating a workstation 100 that allows an operator to access a plurality of computer systems 102A-N. The computers 102A-N can be connected to a network 104.

Each computer system 102A-N provides operator interface signals 108 that usually include keyboard, video, and mouse signals, which allow an operator to provide input to and receive output from the computer system via a keyboard, video display, and mouse, respectively, as will be appreciated by those skilled in the art.

In the system 100, the operator interface signals 108 of each computer system 102A-N are applied to a single keyboard/video/mouse (KVM) switch 110 that couples the operator interface signals of a selected computer system 102A-N to a video display 112, keyboard 114, and mouse 116 in response to control inputs 118 applied by a user (not shown). In operation, a user applies the control inputs 118 to the KVM switch 110 to select the desired computer system 102A-N. In response to the applied control inputs 118, the KVM switch 110 couples the operator interface signals 108 of the selected computer system 102A-N to the video display 112, keyboard 114, and mouse 116. The operator thereafter accesses the selected computer system 102A-N through the video display 112, keyboard 114, and mouse 116 and takes desired action like e.g. looking at pictures sent to the computer through the network 104 and generated by a remote camera, verifying the state of valves, sensors etc . . . in a plant; the data being represented synthetically on a schematics of the plant. The KVM switch 110, video display 112, keyboard 114, and mouse 116 can be located on a desk, allowing the operator to access all of the computer systems 102A-N in the network 106 from a single location.

While the single KVM switch 110 and associated video display 112, keyboard 114, and mouse 116 provide a convenient single location for the operator to access all of the computer systems 102A-N, the operator does not have an overview of data available on the different computers 102A-N. In many instances, it is desirable to be able to view at the same time the images taken by the remote camera and the state of valves, sensors etc . . . of the plant. Indeed, if for instance a fire declares itself in the area monitored by the camera while the operator is looking at the state of a valve or the output of a sensor, precious time will be lost before the operator returns to the images of the camera. The more different computers will have to be consulted each time by activating the KVM switch, the more acute the problem becomes.

The operator system 100 is also limited in the number of computer systems 102A-N that can be coupled to a single KVM switch 110. Thus, where a relatively large number of computer systems must be accessed, a single KVM switch 110 may not be used. As an alternative, multiple KVM switches 110 may be utilized but this increases the complexity of selecting the desired computer system 102A-N and also increases the cost of the system 100.

FIG. 2, corresponding to FIG. 2 of US2003/0037130 by Rollins, illustrates another known control room workstation 200 for providing an operator with access to a plurality of computer systems 202A-N interconnected through a communications network 204 to form a computer network 206. Each computer system 202A-N includes a remote access software component 208 that provides communications with a remote access system 210 over the communications network 204. More specifically, the remote access system 210 includes a remote access software component 212 that communicates over the communications network 204 with the remote access software components 208 running on the computer systems 202A-N. The remote access system 210 also includes a keyboard, video display, and mouse that allow the operator to provide input to and receive output from the remote access system.

In operation, the remote access software component 212 on the remote access system 210 allows the operator to select the computer system 202A-N to be accessed, and thereafter communicates over the communications network 204 with the corresponding remote access software component 208 on the selected computer system. The remote access software component 212 and remote access software component 208 operate in combination to allow the operator to access the selected computer system 202A-N over the communications network 204 as if the operator were using a keyboard, video display, and mouse directly coupled to the computer system. An example of a commercially available software package that may be utilized for the remote access software components 208, 212 is pcAnywhere, which was available from Symantec Corp., as will be appreciated by those skilled in the art.

The system 200 still requires the operator to access the remote computer sequentially which does not provide the operator with a simultaneous overview of the information he can access on all the computers 202A-N.

Solutions exist that allow an operator to interact with multiple displays through a single keyboard and a single mouse. Keyboard and mouse are connected to a (single) computer and the displays are connected to the two or more video outputs usually available on that computer.

There is for instance the software “Actual Multiple Monitors” from Actual Tools (www.actualtools.com) that allows distributing windows across several displays. It is even possible to expand a background picture across several displays thereby giving a tiled version of a single image (i.e. a picture is divided in e.g. N pieces, each piece being displayed as background on one of the N display. The N display disposed side to side giving a tiled representation of the picture).

The problem with these solutions is that the number of displays with which an operator can interact with a single keyboard and a single mouse is limited by the number of video outputs on the computer to which the keyboard and mouse are connected. These solutions also often depend on specific operating systems which may not be desirable.

Solutions exist that allow an operator to interact with multiple displays through a single keyboard and a single mouse without being limited by the number of video outputs on a single computer.

There is for instance the application software called Synergy. In Synergy, a computer plays the role of server and shares its keyboard and mouse with one or more client desktops.

Each client runs its own application and displays the associated output on a display connected to that client. In principle, an arbitrary number of clients and displays can be added to an operator workstation by establishing an Ethernet connection between client and server.

Unfortunately, this type of software is also very dependent on the operating system and does not offer the possibility of (easily) distributing the output of a single application across two or more displays.

### SUMMARY OF THE INVENTION

Embodiments of the present invention are aimed at providing a system and/or a method and/or apparatus and/or software with which an operator can simultaneously access and evaluate data available on different computers or sources, the data being displayed on one or more display devices and interaction with the displays being done through one keyboard and one mouse. Furthermore, Embodiments of the present invention are aimed at providing a system and/or a method and/or apparatus and/or software that is flexible enough to allow the addition of an arbitrary number of operator's workstations to it with as little impact on the existing implementation. It should also be possible to easily modify the number of displays on a given workstation. It should also be possible to easily transfer visual data from one display to another as well as tiling an image across several displays. There is room for improvement in the art.

A display system for displaying image data according to embodiments of the present invention comprises one or more, e.g. a plurality of thin client units, the thin client units comprising processing means and a memory,
a shared resource network linking the plurality of thin client units, the shared resource network being adapted to receive a plurality of input source signals encoding images to be displayed,
a plurality of display units, the display units being for display of at least some of the images encoded in the input source signals,
wherein each thin client is connected to one or more display units and wherein each thin client unit runs one browser per display unit to which it is connected. It is an advantage of the present invention that the use of one browser per display unit facilitates integration and extension of the display system.

A thin client can be a laptop computer, a desktop computer, a smart phone, a PDA or similar that is operated as a thin client.

The shared resource network can be e.g. a local area network.

The shared resource network can combine a local area network and a wide area network like e.g. the internet.

In another aspect of the invention, a human interface like a keyboard and/or a pointer device (e.g. a mouse) connected to a thin client is used to interact with the images displayed on at least two display units.

It is an advantage of the present invention that it facilitates the realization of tiled displays under the control of an operator like e.g. a control room operator. Such tiled displays comprise at least two display units. The two display areas of the at least two display units are used to render image data in an integrated way. By integrated way means that the use of at least two display units brings more to the operator than the mere sum of the images displayed separately on each of the at least two display units. The use of one browser per display unit facilitates the transfer (by e.g. dragging and dropping) of images from the display area of a first display unit onto the display area of a second display unit. For instance, the use of browsers, e.g. the use of one browser per display unit facilitates the realization of tools for interaction between two display areas without having to use “hot keys” as is often the case with the multiscreen computers of the prior art.

In a further aspect of the present invention, the interaction between the display areas of two or more display units is done by inter-browser messaging. In inter-browser messaging, a first browser that determines what is displayed on a first display unit sends a message over the shared resource network to a second browser that determines what is displayed on a second display unit. In function of the content of the message it received from the first browser, the second browser may adapt what is displayed on the second display unit.

It is an advantage of this aspect of the invention that it facilitates interaction between display areas of display units like e.g. dragging and dropping images from one display area onto a second display area.

In particular, the first and second browser can be run on the same thin client. Even in that case, the first browser will exchange data with the second browser by means of the shared resource network.

The first browser can send a message to the second browser by the intermediary of a server connected to the shared resource network.

The message sent by the first browser can contain information on the position of the first and/or the second display unit associated with the first and second browser.

The message sent by the first browser can contain information on an input source signal. The input source signal can be an input source signal encoding image being displayed on the first display unit.

The position of a display unit can be represented by a first parameter W associated with the workspace to which the display would belong. A workspace being a display area composed of the display areas of at least two display units (i.e. a tiled display).

The position of a display within a workspace can be represented by a second parameter Z and a third parameter P.

In a regular tiled display where display units are aligned in rows and columns, Z and P may be seen as the row and the column at the intersection of which the display unit is located. More generally, Z and P can be used for less regular arrangements.

In another aspect the present invention provides a method of displaying image data on a display system having a plurality of thin client units, each thin client unit comprising processing means and a memory, a shared resource network linking the thin client units, the shared resource network being adapted to receive a plurality of input source signals encoding images to be displayed, and a plurality of display units, the method comprising:

displaying on the display units being at least some of the images encoded in the input source signals,

wherein each thin client is connected to one or more display units and wherein each thin client unit runs one browser per display unit to which it is connected, the browser determining what is displayed on the display unit.

In another aspect the present invention provides a workstation for use in a display system for displaying image data, the workstation being a thin client unit of a network, the thin client unit comprising processing means and a memory and being adapted to be connectable to a shared resource network linking the thin client unit to other thin client units, the thin client unit being adapted to receive a plurality of input source signals encoding images to be displayed,
wherein the thin client unit is adapted to be connected to two or more display units and wherein the thin client unit runs one browser per display unit to which it is connected, the browser determining what is displayed on the two or more display units.

In another aspect the present invention provides a computer program product which when executed on a processing engine carries out any of the methods of the present invention. A non-transient signal storage medium can store the computer program product of claim 21.

### BRIEF DESCRIPTION OF THE FIGURES

FIG. 1 shows a functional block diagram illustrating a workstation according to the prior art that allows an operator to access a plurality of computer systems.

FIG. 2 is a schematic representation of another control room workstation of the prior art for providing an operator with access to a plurality of computer systems interconnected through a communications network to form a computer network.

FIG. 3 shows an example of display system according to an embodiment of the present invention.

FIG. 4 shows an example of display system according to an embodiment of the present invention.

FIGS. 5, 6 and 7 give a schematic representation of the transfer of an image from one display unit to another of a given workspace according to embodiments of the present invention.

FIG. 8 shows an example of sequence of steps to drag a frame on the display area of a first display unit and drop it on the display area of a second display unit according to an embodiment of the present invention.

FIG. 9 gives an example of how the parameters Z and P can be assigned to the display units of a given workspace W.

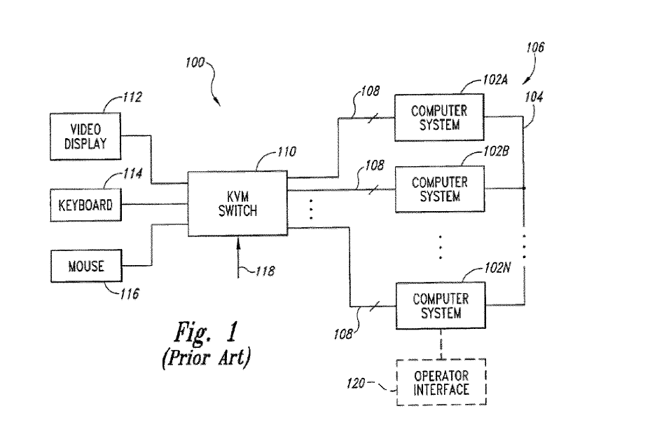

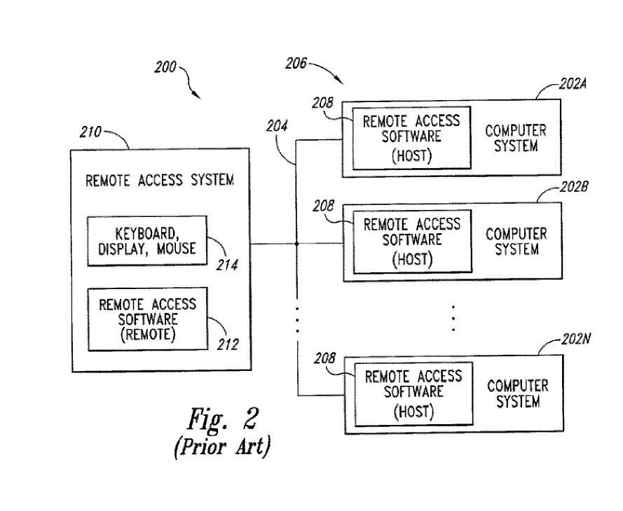

### DEFINITIONS

“Shared resource network” refers to a network in which a computer resource is made available from one host to other hosts on the network. This allows a device to be accessed remotely. For example a piece of information on a first computer connected to the network can be accessed remotely from another computer. Examples are a local area network or an enterprise intranet. A remote computer can be accessed transparently as if it were a resource in the local machine. Network resource sharing is made possible by inter-process communication over the network.

A “thin client unit” or “thin client” is a network access enabled device such as a computer that can correspond with a remote server, the OWS server. The thin client unit depends heavily on another computer such as its server (OWS server) to perform the computational and processing features of a stand-alone computer. Specific roles assumed by the server (OWS server) can be hosting a shared set of virtualized applications, a shared desktop stack or virtual desktop, data processing and file storage on the client or users behalf. Thin client hardware is a device which provides I/O for a keyboard, mouse, display, monitor or VDU, jacks for sound peripherals, and open ports for USB devices, e.g. printer, flash drive, web cam, card reader, smartphone, etc. Thin clients can include legacy serial and/or parallel ports to support older devices such as receipt printers, scales, time clocks, etc. Thin client software typically consists of a GUI (graphical user interface), remote/cloud access agents (e.g. RDP, ICA, PCoIP), a local web browser, terminal emulations (in some cases), and a basic set of local utilities.

“Interbrowser signalling” refers to the ability of a first browser to communicate with a second browser over the network, e.g. in accordance with “Real time communication between browsers”, WebRTC 1.0 (provided by W3C) defines a set of ECMAScript APIs in WebIDL to allow media to be sent to and received from another browser or device implementing the appropriate set of real-time protocols. An RTCPeerConnection allows two users to communicate directly, browser to browser. Communications are coordinated via a signaling channel which is provided by unspecified means, but generally by a script in the page via the server, e.g. using XMLHttpRequest.

### DESCRIPTION OF PREFERRED EMBODIMENTS

The present invention will be described with respect to particular embodiments and with reference to certain drawings but the invention is not limited thereto but only by the claims. The drawings described are only schematic and are non-limiting.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

References to software can encompass any type of programs in any language executable directly or indirectly by a processor.

References to logic, hardware, processor or circuitry can encompass any kind of logic or analog circuitry, integrated to any degree, and not limited to general purpose processors, digital signal processors, ASICs, FPGAs, discrete components or transistor logic gates and so on.

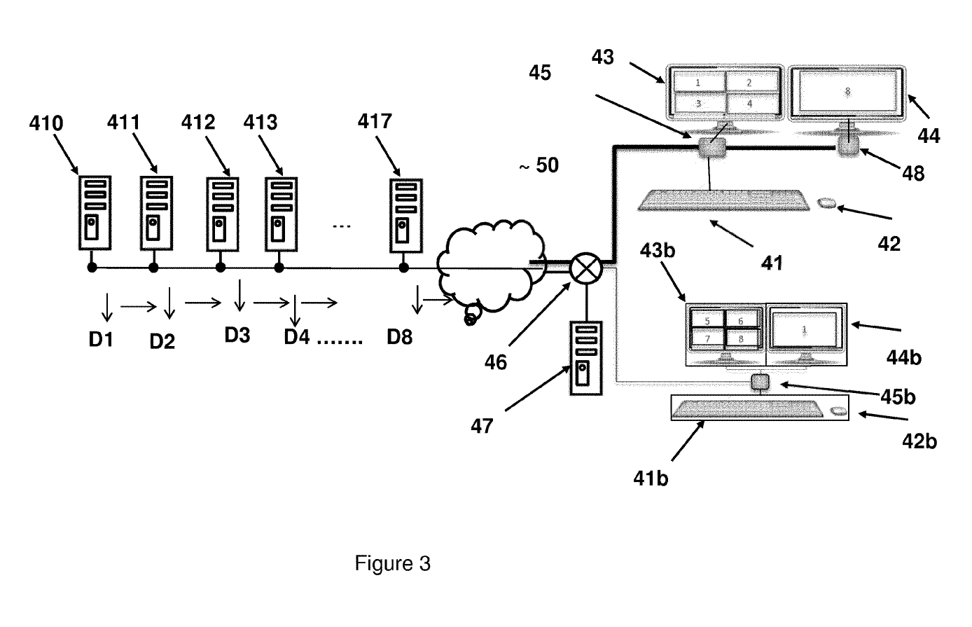

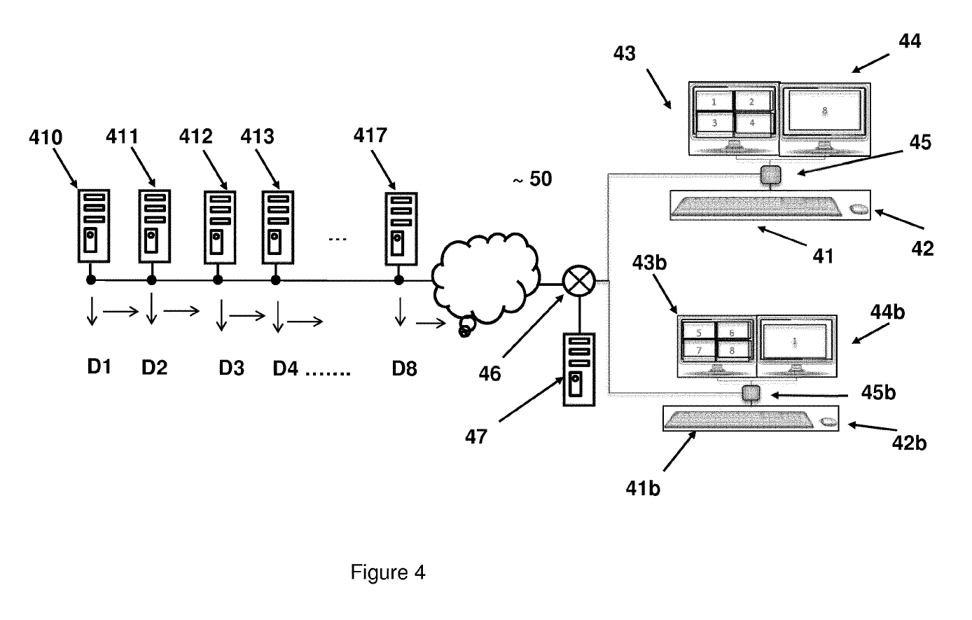

FIG. 3 shows a first preferred embodiment of the invention and FIG. 4 shows a modification of this first embodiment of the invention.

In the display system of FIG. 3 or 4, one or more computers 410, 411, 412, 413, and 417 are sources of information or content. These computers are connected to a network 50 used to share information resources. Each of these computers can run one or more programs and is a source of input (for other devices connected to the shared resource network 50) and generates data or input source signals that can be displayed. In this example, the software run on computer 410 generates displayable data D1, computer 411 generates displayable data D2 . . . The displayable data can be images taken by a camera connected to a computer (like e.g. a webcam) and allow the operator to monitor a specific location (like e.g. a platform in a train station, the spectator area in a stadium, a portion of an highway . . . ). The displayable data can be pre-recorded images stored on the computer or on a CD-ROM readable by the computer. The displayable data can also be a map, updated by the computer in function of external events (like e.g. traffic density). The displayable data can also be any type of information usually displayed on computers like e.g. spreadsheets, results of simulations, archived photos or video recordings, web pages . . .

The displayable data (which can be shared or transferred between different computers) can be anything accessible as a URL within the network.

Local display data on a computer 410, 411 etc . . . 417 can be e.g. made available on a URL which makes it easily accessible on the shared resource network.

Encoders may be provided for encoding image data to be displayed so as to generate the input source signals.

These encoders may comprise coder logic for compressing data related to images to be displayed. For example, the codec logic can be a JPEG2000 logic. The encoders can be software encoders run on the computers 410, 411 . . . or can be hardware encoders connected to computers 410, 411 . . .

On FIG. 4, a workstation for a control room operator comprises a keyboard 41, a pointer device such as a mouse 42, a first display 43 and a second display 44. The keyboard, the mouse and both screens are connected to a thin client 45. The first and second displays 43 and 44 can be e.g. LCD displays, projector and the associated projection screen (for front or rear projection), LED displays etc . . .

The thin client 45 is connected to the shared resource network 50 through a network switch 46. A server 47 is connected to the same network e.g. it can be connected to the same network switch 46. The thin clients can be desktop or laptop computers operated as thin clients. A thin client controls what is displayed on a display to which it is connected. The thin client contains for instance a graphical processing unit or GPU.

Each thin client runs one browser per display to which it is connected. The browser is a software application for retrieving, presenting and traversing information resources identified by a Uniform Resource Identifier (URI/URL) that can be a web page, image, video or other information generated by one of the computers 410, 411 . . . and/or 417 connected to the network 50. In the example of FIG. 4, the thin client 45 runs two browsers. A first browser determines what is displayed on display 43 and a second browser determines what is displayed on display 44.

The browsers can retrieve and render data generated by different sources. For instance, the first browser can retrieve and render display data D1, D2, D3 and D4 on the first display 43 while the second browser can retrieve and render display data D8 on the second display 44. The thin clients 45, 45b may comprise decoder logic for decompressing data related to images to be displayed. The decoder logic can be a JPEG2000 logic, for example.

The display data to be retrieved and rendered by a browser on a specific display can be determined e.g. by instructions encoded in a markup language like e.g. html5. The instructions may be written by an operator and stored locally on the thin client 45 or on server 47. The instructions might also be generated automatically by a graphical user interface. The instructions determine which input source signals must be displayed and how it must be displayed (position of image on the display, scaling etc . . . ).

If there are two or more displays on an operator's desk and if a thin client can only drive one display at a time, the first thin client 45 is connected to the first display 43 and a second thin client 48 is connected to the second display 44 and so on as shown in FIG. 3. The keyboard 41 and the mouse 42 are connected to the first thin client 45. The operator can control the second thin client 48 by means of signals sent by the first thin client 45 to thin client 48 over the shared resource network 50. An arbitrary number of thin clients 48 . . . can be under the control of an operator with a single mouse and keyboard. Both client 45 and client 48 can e.g. run a network based Keyboard and Mouse sharing software for which the client 45 is configured as a server that we will call the KM server to avoid confusion with other servers connected to the shared resources network and in particular the server 47 that we will refer to as the Operator WorkStation server or OWS server.

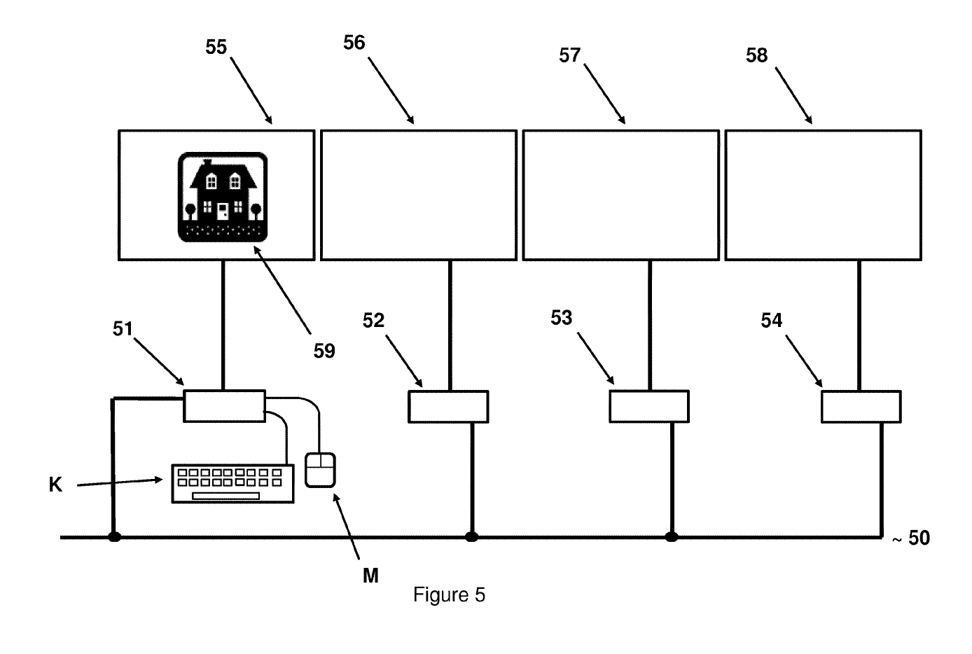

Let us consider an Operator Workstation with four thin clients 51, 52, 53, 54 each connected to a single display 55, 56, 57 or 58 as shown in FIGS. 5 to 7. The displays are positioned next to each other. In this example of embodiment, the displays are in a row. The tiled display area composed of the display areas of displays 55, 56, 57 and 58 will be referred to as a workspace. Display 55 is the Leftmost display and display 58 is the Rightmost display. The clients 51, 52, 53, 54 are connected to a shared resource network 50. A Keyboard K and a mouse M are connected to client 51. The clients 51, 52, 53, 54 run a Keyboard and Mouse sharing software. One browser is opened on each of the displays (in other words, one browser application is opened on each of the thin clients 51, 52, 53, 54 respectively connected to the display 55, 56, 57 and 58 as seen on FIGS. 5, 6 and 7). When a browser is opened (and executes a code in e.g. html indicating among other things which image sources should be used), it establishes a socket between the OWS server and said browser.

Each display is assigned an identifier that consists of three parameters: a first parameter W indicates the operator workstation, a second parameter Z indicates the row (of displays) where the display is located and a third parameter P indicates the position of the display in the row.

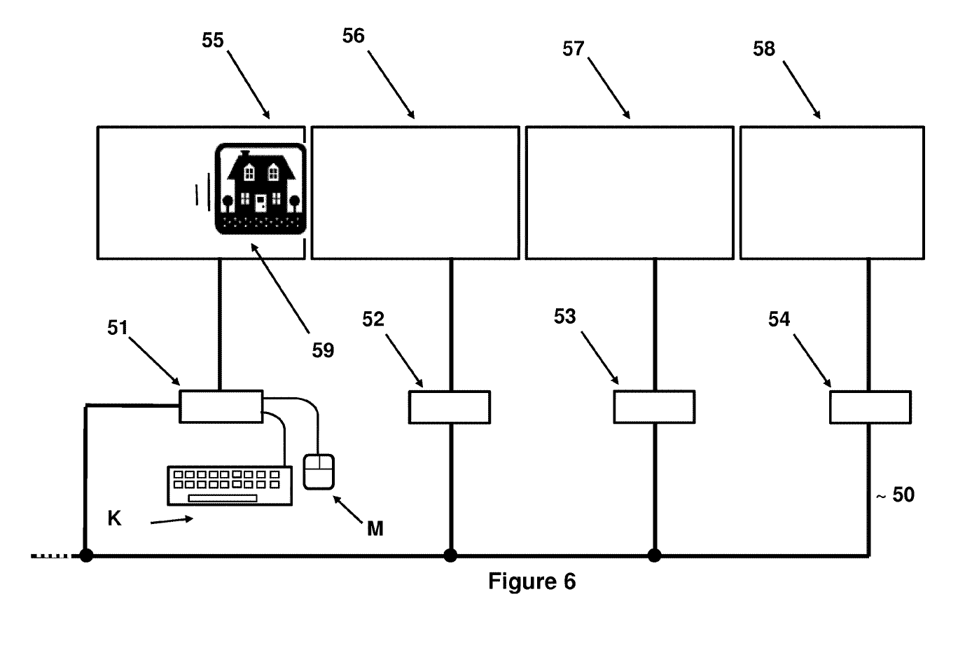

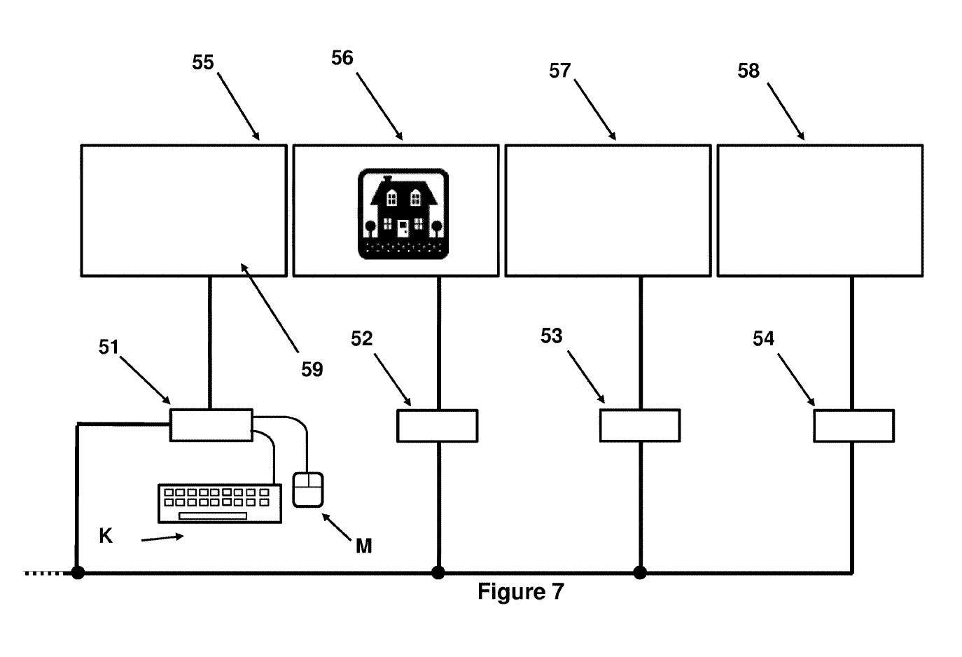

In the example of FIG. 5 (or FIGS. 6 and 7), the leftmost display is assigned the identifier W=1, Z=1 and P=1, the next display is assigned the identifier W=1, Z=1 and P=2, the following display is assigned the identifier W=1, Z=1 and P=3 and the rightmost display is assigned the identifier W=1, Z=1 and P=4. There being a one-to-one correspondence or “bijection” between browsers and displays, the identifier WZP can also identify unequivocally a browser in a display system according to the invention.

The browser associated to display 55 can e.g. contain one or more frames, each frame rendering an image or video encoded in an input source signal. For the sake of simplicity, let us assume that it has a single frame 59, smaller than the browser window as seen on FIG. 5 (or 6 or 7). In the course of his work, an operator may decide that the frame seen on display 55 (P=1) would be better displayed on e.g. display 56 (P=2). Solutions exist that allow dragging windows from one display to another. “Actual Multiple Monitors” for instance allows dragging a window from a first screen and drop it onto a second screen but only when the first and second screens are connected to the same computer. In order to make this possible for displays connected to different client computers and at the same time ensure compatibility with as much operating systems and hardware as possible, the present invention uses messaging between browsers.

If the frame 59 is dragged across the first browser until the right edge of said first browser and stays there for more than a time Δt (as seen on FIG. 6), an event “cross right edge” is generated and sent by the first browser to the OWS server 47 together with the input source signal detail (e.g. URL where the input source signal can be found) and the identifier WZP for the destination browser (in this case the second browser associated with display 56 (P=2). The OWS server then forwards this information to the destination browser where the frame originally rendered in the first browser is eventually opened (as seen on FIG. 7).

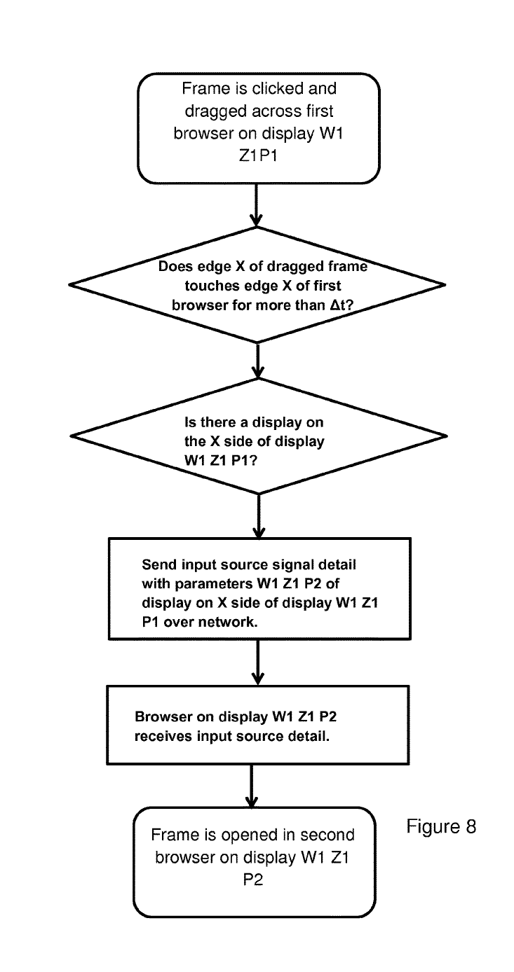

An example of sequence of steps taken to drag a frame on a first display and drop it on an adjacent display (the display area of both display being part of the same workspace or in other words, both displays having the same value for the parameter W) is given on FIG. 8. As will be appreciated by those skilled in the art, the method can be implemented in different ways that can be function of the code language.

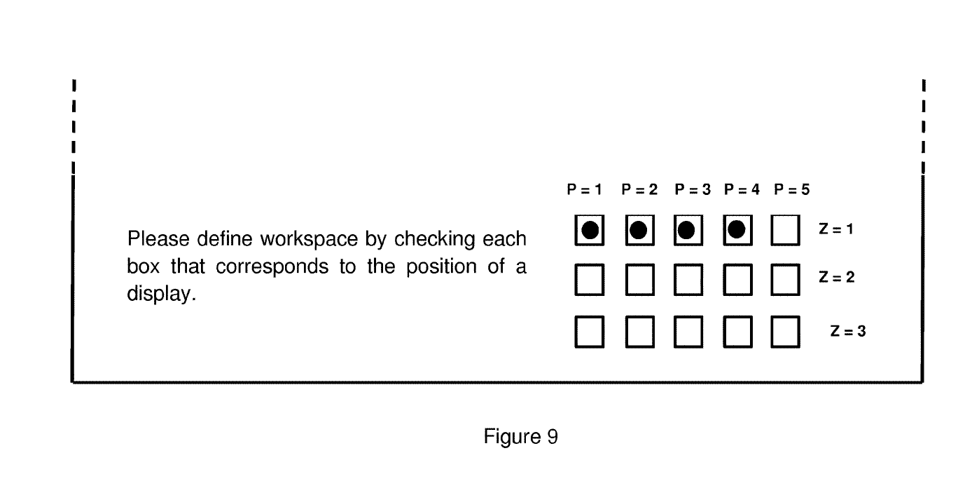

Determining whether or not there is a display adjacent to the display on which frame 59 is dragged can be done e.g. manually: the operator can “set-up” his workspace by entering constants manually for each browser (in the code itself or through a user interface that can be “embedded” in the browser, an example of which is seen on FIG. 9) which displays are available for the workspace W used by the operator as well as their relative position. In FIG. 9, at the bottom of the browser 90, 3×5 boxes can be checked to define the geometry of the workspace to which the browser 90 belongs. In the example of FIG. 9, only 4 boxes have been checked corresponding to Z=1 and P=1 to 4 and determine the geometry and relative position of the display of a workspace like the one represented on FIGS. 5, 6, 7.

As is seen on FIG. 9, the workspace can be as in a regular tiled display where display units are aligned in rows and columns, Z and P may be seen as the row and the column at the intersection of which the display unit is located.

More generally, W, Z and P can be used for less regular arrangements.

When clients can drive two or more displays, thanks to the one to one correspondence between browsers and displays, the inter-browser messaging as described is still applicable. In other words, for a multi-screen computer, a first browser running on the multi-screen computer still sends information to a second browser running on the same multi-screen computer over the shared resource network. This makes integration of display system with different types of thin clients and/or full-fledged computers easier than otherwise.

An operator workspace as described here above can easily be added to an existing shared resources network and this with a lot of hardware flexibility.

All it takes are clients that can run a browser (and depending on design variations, application like Javascript) and send and receive messages over an IP network.

To illustrate this, let us assume that the display system of FIG. 3 or 4 already exists e.g. to monitor a production plant. A first operator whose workspace consists of the display area of displays 43 and 44 monitors e.g. a first bioreactor and a second operator whose workspace consists of the display area of displays 43b and 44b monitors e.g. a second bioreactor. If the production plant is expanded by e.g. protein purification processes like e.g. a chromatography column requiring capture of parameters different from those of bioreactors 1 and 2, all it takes is to treat the acquisition system associated with the chromatography column (e.g. sensors, AD convertors, a computer to read-out the AD convertors and the assorted software to process the data recorder from the AD convertors, process it and send it over an IP network like the shared resource network 50) as an additional input signal source. The additional input signal source is connected to the shared resource network 50 and a third workstation according to this invention is connected to the shared resource network with the only limitation that the one or more client associated to the third workstation be able to run a browser (i.e. to execute an almost universal language like a markup language). The displays of the third workspace will be identified by their own Z and P in the workspace for which the parameter W is set to 3.

The present invention relates to a variety of digital devices with processing capability such as thin clients, switches, servers etc. Each one of these can include one or more microprocessors, processors, controllers, or central processing unit (CPU) and/or a Graphics Processing Unit (GPU), and can be adapted to carry out their respective functions by being programmed with software, i.e. one or more computer programmes.

Any, some or all of these devices may have memory (such as non-transitory computer readable medium, RAM and/or ROM), an operating system, a display such as a fixed format display, human interface data entry devices such as a keyboard, a pointer device such as a “mouse”, serial or parallel ports to communicate other devices, network cards and connections to connect to network.

The software can be embodied in a computer program product adapted to carry out the following functions when the software is loaded onto the respective device or devices and executed on one or more processing engines such as microprocessors, ASIC's, FPGA's etc.:

displaying image data on display units having processing means and a memory, and thin client units sharing a network, and receiving a plurality of input source signals encoding images to be displayed.

The software can be embodied in a computer program product adapted to carry out the following functions when the software is loaded onto the respective device or devices and executed on one or more processing engines such as microprocessors, ASIC's, FPGA's etc.:

running a bowser on each thin client unit per display unit to which it is connected, the browser determining what is displayed, and displaying at least some of the images encoded in the input source signals.

The software can be embodied in a computer program product adapted to carry out the following functions when the software is loaded onto the respective device or devices and executed on one or more processing engines such as microprocessors, ASIC's, FPGA's etc.:

a first browser corresponding to a first display unit sending a message over network to a second browser corresponding to a second display unit, and/or

sending inter-browser signals through the network.

The software can be embodied in a computer program product adapted to carry out the following functions when the software is loaded onto the respective device or devices and executed on one or more processing engines such as microprocessors, ASIC's, FPGA's etc.:

interacting with the images displayed on at least two display units connected to one thin client using a human interface device, and/or

a thin client interacting with the images displayed on at least two display units connected to different thin clients, and/or

a single thin client interacting with the images displayed on at least two display units connected to the same thin client with a single human interface connected to the single thin client.

The software can be embodied in a computer program product adapted to carry out the following functions when the software is loaded onto the respective device or devices and executed on one or more processing engines such as microprocessors, ASIC's, FPGA's etc.:

a first browser corresponding to a first display unit sending a message over the network to a second browser corresponding to a second display unit to modify the image displayed on the second display unit, and/or

the first and second browsers are running on the same thin client.

The software can be embodied in a computer program product adapted to carry out the following functions when the software is loaded onto the respective device or devices and executed on one or more processing engines such as microprocessors, ASIC's, FPGA's etc.:

the first browser sending a message to the second browser by the intermediary of a server connected to the network, and/or

message sent over the network to the second browser corresponding to the second display unit, comprising a location key which has a first parameter associated to the workspace to which the second display unit belongs, and/or

the location key includes a second and a third parameter associated with the relative position of display units in the workspace.

Any of the above software may be implemented as a computer program product which has been compiled for a processing engine in any of the thin clients, servers or nodes of the network. The computer program product may be stored on a non-transitory signal storage medium such as an optical disk (CD-ROM or DVD-ROM), a digital magnetic tape, a magnetic disk, a solid state memory such as a USB flash memory, a ROM, etc.

1-23. (canceled)

24. A display system for displaying image data, comprising:
a plurality of thin client units, each comprising processing means and a memory,
a shared resource network linking the thin client units, the shared resource network being adapted to receive a plurality of input source signals encoding images to be displayed,
a plurality of display units, the display units being for display of at least some of the images encoded in the input source signals,
wherein each thin client is connected to one or more display units and wherein each thin client unit runs one browser per display unit to which it is connected, the browser determining what is displayed on the display unit so that there is a one-to-one bijectional correspondence between browsers and display units, wherein a browser is identified unequivocally in the display system.

25. The display system according to claim 24 wherein the shared resource network is selected from a local area network and a combination of a local area network and a wide area network.

26. The display system according to claim 24 wherein a single human interface is connected to a single thin client and its configuration is selected from:
for interaction with the images displayed on at least two display units,
for interaction with the images displayed on at least two display units connected to different thin clients, and
for interaction with the images displayed on at least two display units connected to the same thin client.

27. The display system according to claim 24 wherein a first browser corresponding to a first display unit sends a message over the shared resource network to a second browser corresponding to a second display unit or
a first browser corresponding to a first display unit sends a message over the shared resource network to a second browser corresponding to a second display unit to modify the image displayed on the second display unit.

28. The display system according to claim 27 wherein the first and second browsers are running on the same thin client.

29. The display system according to claim 27 wherein the first browser sends a message to the second browser by the intermediary of a server connected to the shared resource network.

30. The display system according to claim 28 wherein the first browser sends a message to the second browser by the intermediary of a server connected to the shared resource network.

31. A method of displaying image data on a display system having a plurality of thin client units, each thin client unit comprising processing means and a memory, a shared resource network linking the thin client units, the shared resource network being adapted to receive a plurality of input source signals encoding images to be displayed, and a plurality of display units, the method comprising:
displaying on the display units being at least some of the images encoded in the input source signals,
wherein each thin client is connected to one or more display units and wherein each thin client unit runs one browser per display unit to which it is connected, the browser determining what is displayed on the display unit so that there is a one-to-one bijectional correspondence between browsers and display units, wherein a browser is identified unequivocally in the display system.

32. The method according to claim 31 wherein the shared resource network is a local area network.

33. The method according to claim 31 wherein the shared resource network combines a local area network and a wide area network.

34. The method according to claim 31 further comprising using a single human interface connected to a single thin client for interaction with the images displayed on at least two display units.

35. The method according to claim 31 further comprising using a single human interface connected to a single thin client for interaction with the images displayed on at least two display units connected to different thin clients.

36. The method according to claim 31 further comprising using a single human interface connected to a single thin client for interaction with the images displayed on at least two display units connected to the same thin client.

37. The method according to claim 31 wherein a first browser corresponding to a first display unit sends a message over the shared resource network to a second browser corresponding to a second display unit, or
wherein a first browser corresponding to a first display unit sends a message over the shared resource network to a second browser corresponding to a second display unit to modify the image displayed on the second display unit.

38. The method according to claim 37, wherein the first and second browsers are running on the same thin client.

39. The method according to claims 37 wherein the first browser sends a message to the second browser by the intermediary of a server connected to the shared resource network.

40. The method according to claims 38 wherein the first browser sends a message to the second browser by the intermediary of a server connected to the shared resource network.

41. A computer program product which when executed on a processing engine carries out the method of claim 31.

42. A non-transient signal storage medium storing the computer program product of claim 41.

43. A workstation for use in a display system for displaying image data, the workstation being a thin client unit of a network, the thin client unit comprising processing means and a memory and being adapted to be connectable to a shared resource network linking the thin client unit to other thin client units, the thin client unit being adapted to receive a plurality of input source signals encoding images to be displayed,
wherein the thin client unit is adapted to be connected to two or more display units and wherein the thin client unit runs one browser per display unit to which it is connected, the browser determining what is displayed on the two or more display units so that there is a one-to-one bijectional correspondence between browsers and display units, wherein a browser is identified unequivocally in the display system.
